(19) United States
(12) Patent Application Publication
(10) Pub. No.: US 2007/0030635 A1
(43) Pub. Date: Feb. 8, 2007

(54) Portable computer

(75) Inventor: Young-shin Song, Yongin-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/485,368

(22) Filed: Jul. 13, 2006

(30) Foreign Application Priority Data
Aug. 4, 2005 (KR) 2005-71250

(51) Int. Cl. G06F 1/16; A47B 88/00

(52) U.S. Cl. 361/683; 292/270; 292/290; 312/333

(57) ABSTRACT

A portable computer includes a computer main body to which an attached object is detachably mounted, a mounting part which is provided in the computer main body to accommodate the attached object, engaging parts which are formed at opposite sides of the mounting part in a transverse direction with respect to a separation direction of the attached object, insertion parts which are formed at opposite sides of the attached object corresponding to the engaging parts, a latch which comprises a locking part locked to each engaging part through each insertion part and an inclination part inclined from the locking part, and is installed to the attached object to slide along the transverse direction with respect to the separation direction of the attached object; and a latch movable part which comprises a stopper provided in a position corresponding to the inclination part, and is movable within the attached object in the separation direction of the attached object, the latch sliding between a locking position where the locking part is locked to the engaging part through the insertion part, and a releasing position where the locking part is released from the engaging part as the inclination part is engaged with the stopper and the inclination part slides by the stopper when the latch movable part moves in the separation direction of the attached object.

### CROSS-REFERENCE TO RELATED APPLICATIONS

This application claims the benefit of Korean Patent Application No. 2005-0071250, filed on Aug. 4, 2005, in the Korean Intellectual Property Office, the disclosure of which is incorporated herein by reference.

### BACKGROUND OF THE INVENTION

1. Field of the Invention

The present general inventive concept relates to a portable computer, and more particularly, to a portable computer in which a user separates an attached object from a computer main body without difficulty.

2. Description of the Related Art

Electronic apparatuses including portable computers comprise an attached object such as a battery cover, a battery pack, etc. The attached object is provided with a locking device so that a user can selectively open or close the attached object, or separate the attached object from the electronic apparatuses.

FIG. 1 is a rear perspective view illustrating a conventional portable computer 101. Referring to FIG. 1, a battery pack 110 is detachably provided in a bottom of the portable computer 101. A pair of knobs 105 is provided in the bottom of the portable computer 101 to unlock the battery pack 110. The pair of knobs 105 is connected with a latch member (not shown) which is provided in the portable computer 101 and comprises a latching part (not shown) locked to and released from a latch engaging part (not shown) of the battery pack 110.

In such a conventional portable computer, a user should move the pair of knobs 105 in a direction to unlock the latching part of the latch member and the latch engaging part of the battery pack 110 to separate the battery pack 110 from the portable computer 101. That is, a user should use both hands to separate the attached object such as a battery pack.

### SUMMARY OF THE INVENTION

Accordingly, it is an aspect of the present general inventive concept to provide a portable computer in which a user separates an attached object from a computer main body with one hand without difficulty.

Additional aspects and/or advantages of the present general inventive concept will be set forth in part in the description which follows and, in part, will be obvious from the description, or may be learned by practice of the present general inventive concept.

The foregoing and/or other aspects of the present general inventive concept may be achieved by providing a portable computer having a computer main body to which an attached object is detachably mounted, a mounting part which is provided in the computer main body to accommodate the attached object, engaging parts which are formed at opposite sides of the mounting part in a transverse direction with respect to a separation direction of the attached object, insertion parts which are formed at opposite sides of the attached object corresponding to the engaging parts, a latch which comprises a locking part locked to each engaging part through each insertion part and an inclination part inclined from the locking part, and is installed to the attached object to slide along a transverse direction with respect to the separation direction of the attached object, and a latch movable part which comprises a stopper provided in a position corresponding to the inclination part, and is movable within the attached object in the separation direction of the attached object, the latch sliding between a locking position where the locking part is locked to the engaging part through the insertion part, and a releasing position where the locking part is released from the engaging part as the inclination part is engaged with the stopper and the inclination part slides by the stopper when the latch movable part moves in the separation direction of the attached object.

The attached object may comprise a battery assembly, and the battery assembly comprises a lower cover having an upward opening and an upper cover coupled to an upper part of the lower cover to close the upper opening.

The latch may comprise the locking part and the inclination part provided in a first portion thereof, a coupling part which is provided in a second portion thereof to be supported within the lower cover, and a flange which protrudes along a circumferential direction between the locking part and the inclination part.

The portable computer may further comprise a latch spring member to elastically move the latch from the releasing position to the locking position, having a first side supported within the lower cover and a second side supported by the coupling part.

The lower cover may comprise a front support which supports the locking part in front of the flange and a rear support which is adjacent to the front support to support the coupling part therein.

The portable computer may further comprise a control knob which is coupled to the latch movable part to integrally move with the latch movable part and to move the latch movable part in the separation direction of the attached object.

The upper cover may comprise an upper surface provided with a knob mounting part to accommodate the control knob and a knob slot which is formed in a plate surface of the knob mounting part, and the control knob may comprise a coupling projection which is provided in a lower part of the control knob to be coupled to the latch movable part within the attached object through the knob slot.

The portable computer may further comprise a guiding unit which guides the latch movable part to allow the latch movable part to move along the separation direction of the attached object in a lower part of the latch.

The guiding unit may comprise a coupling boss to protrude from the lower cover, a guiding slot formed in the latch movable part to correspond to the coupling boss and a coupling member inserted to the guiding slot to be coupled to the coupling boss.

The portable computer may further comprise a latch movable part spring member which elastically returns the latch movable part to an original position.

The foregoing and/or other aspects of the present general inventive concept may also be achieved by providing a portable computer having a computer main body and a battery assembly detachably attached to the computer main body, the portable computer comprising a mounting part formed in the computer main body so that the battery assembly is mounted in and separated from the computer main body in a first direction, a latch to move between locking and unlocking positions in a second direction to lock and unlock the battery assembly to and from the mounting part, respectively, and a latch movably part to move in the first direction to control the latch to move in the second direction between the locking and unlocking positions.

The foregoing and/or other aspects of the present general inventive concept may also be achieved by providing a portable computer having a computer main body and a battery assembly detachably attached to the computer main body, the portable computer including a mounting part formed in the computer main body so that the battery assembly is mounted in and separated from the computer main body in a first direction, a latch movable part to move in the first direction, and a latch having a first portion to convert a first force generated from the latch movable part in the first direction into a second force in a second direction, and a second portion to move between locking and unlocking positions in the second direction according to the second force of the first portion to lock and unlock the battery assembly to and from the mounting part, respectively.

### BRIEF DESCRIPTION OF THE DRAWINGS

The above and/or other aspects and advantages of the present general inventive concept will become apparent and more readily appreciated from the following description of the embodiments, taken in conjunction with the accompanying drawings of which:

FIG. 1 is a rear perspective view illustrating a conventional portable computer;

FIG. 2 is a rear perspective view illustrating a portable computer according to an embodiment of the present general inventive concept;

FIG. 3 is a schematic exploded perspective view illustrating a battery assembly of the portable computer of FIG. 2;

FIG. 4 is a schematic coupling view illustrating an installing area of a latch of the battery assembly of FIG. 3; and

FIGS. 5A, 5B, and 5C are operational views of the battery assembly of FIG. 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

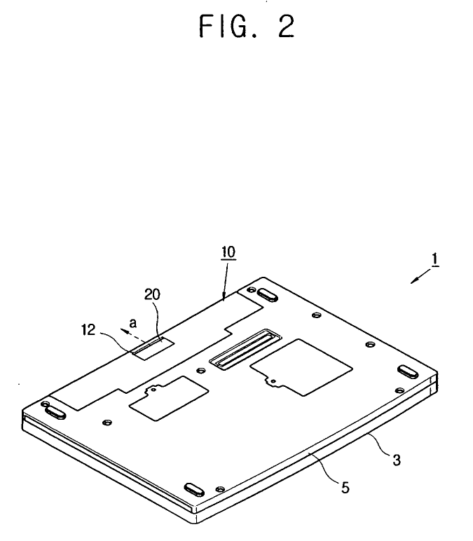

FIG. 2 is a rear perspective view illustrating a portable computer 1 according to an embodiment of the present general inventive concept. Referring to FIG. 2, the portable computer 2 comprises a computer main body 5 which is mounted with a plurality of hardware, i.e., electrical components and/or mechanical components, and a display part 3 which is rotatably coupled to the computer main body 5 to display an image thereon.

A battery assembly 10 is detachably coupled to a bottom of the computer main body 5, as an attached object. A control knob 20 is provided on an upper part of the battery assembly 10 to move in an “a” direction of FIG. 2 to separate the battery assembly 10 in the “a” direction thereof.

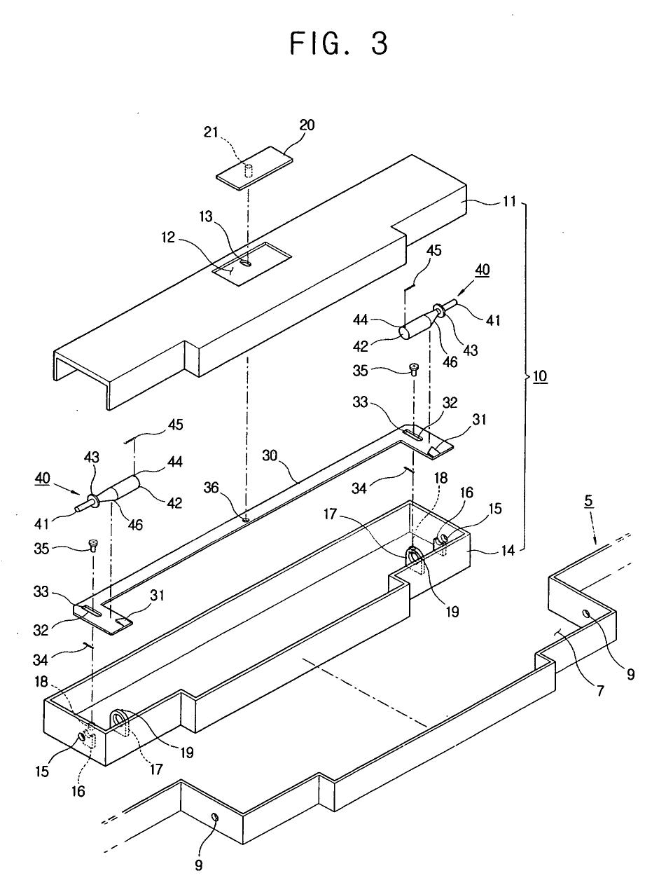

As illustrated in FIG. 3, a battery mounting part 7 is provided in the computer main body 5 to mount the battery assembly 10 thereon as a mounting part to correspond to a shape of the battery assembly 10. Locking holes 9 are formed in opposite lateral sides of the battery mounting part 7 as an engaging part, to engage latches 40 (to be described later) provided in the battery assembly 10.

The battery assembly 10 comprises a lower cover 14 which is shaped like a box and comprises an upward opening, and an upper cover 11 which is coupled to an upper portion of the lower cover 14 to close the upward opening. Various components are placed in an internal space formed by the upper and lower covers 11 and 14. The various components accommodated in the internal space formed by the upper and lower covers 11 and 14 are well-known, and thus descriptions thereof are omitted.

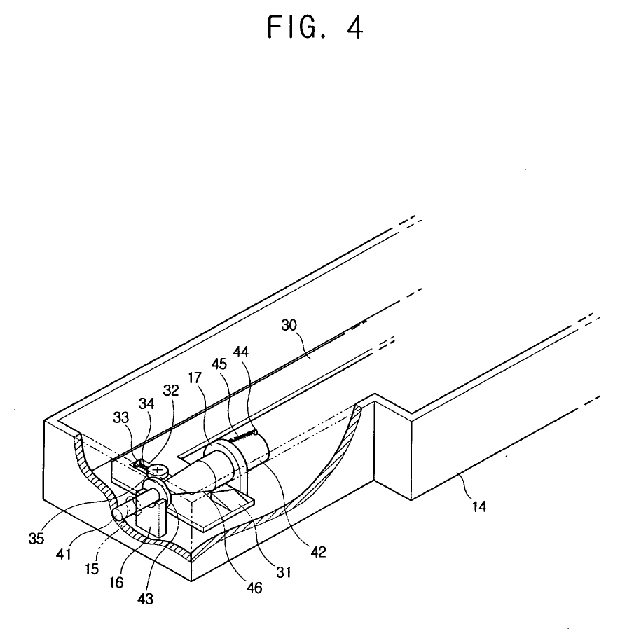

As illustrated in FIGS. 3 and 4, the lower cover 14 of the battery assembly 10 comprises a pair of latches 40 which elastically moves between a locking position where the pair of latches 40 is locked to the respective locking holes 9 and a releasing position where the pair of latches 40 is released from the respective locking holes 9, and a latch movable part 30 which operates together with the control knob 20 to move the pair of latches 40 between the locking position and the releasing position. The latch moveable part 30 and the control knob 20 may be formed in an integral body to move together in the same direction, for example, separation and/or insertion directions of the battery assembly 10.

The lower cover 14 comprises a front and rear supports 16 and 17 to support a movement of the latches 40, a through hole 15 formed on lateral side plates of the lower cover 14 as an insertion part which is adjacent to the front support 16, and a coupling boss 18 to be coupled with the latch movable part 30.

The pair of latches 40 comprise a locking part 41 which is supported by the front support 16 and passes through the through hole 15 to be inserted to the locking hole 9 of the battery mounting part 7, a coupling part 42 which is supported by the rear support 17, an inclination part 46 which is provided between the locking part 41 and the coupling part 42, and a flange 43 which is provided between the inclination part 46 and the locking part 41. The inclination part 46 converts a first force generated from the latch movable part 30 in the separation direction into a second force to control the latch 40 to move in a direction between the locking position and the releasing position.

The latches 40 may elastically move between the locking position where the locking part 41 is locked to the computer main body 5 through the locking hole 9 by a first spring member 45 and the releasing position where the locking part 41 is released from the locking hole 9.

The spring member 45 includes a first part coupled to a first spring support projection 19 which is formed on the rear support 17, and a second part coupled to a second spring support projection 44 which is formed on the coupling part 42 of the latch 40. The first spring member 45 causes the latch 40 to be biased to the battery mounting part 7.

The latch movable part 30 has a sectional shape of “n” or a shape having a middle plate and side plates extended from opposite sides of the middle plate toward the latch 40. The latch movable part 30 is coupled with the control knob 20 by a coupling unit to move together with the control knob 20.

The coupling unit comprises a coupling hole 36 which is formed in a plate surface (or the middle plate) of the latch movable part 30, and a coupling projection 21 which protrudes from a lower surface of the control knob 20 and is coupled to the latch movable part 30 through the coupling hole 36 and a knob slot 13 formed in the knob mounting part 12. In the present embodiment, the coupling hole 36 is provided in the latch movable part 30, and the coupling projection 21 is provided in the control knob 20, but not limited thereto. Alternatively, the coupling projection 21 may be provided in the latch movable part 30, a projecting part of the coupling projection 21 may be projected from an upper surface of the latch movable part 30, and the coupling hole 36 may be formed in the control knob 20 to receive the projection part of the coupling projection 21, thereby coupling the control knob 20 and the latch movable part 30 each other.

The latch movable part 30 receives an elastic force from a second spring member 34 as a latch movable part spring member to elastically move together with the control knob 20 in a transverse direction with respect to a moving direction of the latches 40. That is, the latch movable part 30 may move in the separation direction of the battery assembly 10.

The latch movable part 30 comprises a guiding slot 32 which is formed in the plate surface of the latch movable part 30, a spring coupling part 33 which is provided in the guiding slot 32, and a stopper 31 which slidably contacts the inclination part 46 of each latch 40.

The movement of the latch movable part 30 is guided by a guiding unit. The guiding unit comprises the guiding slot 32 of the latch movable part 30, the coupling boss 18 of the lower cover 14, and a screw 35 as a coupling member which is coupled to the coupling boss 18 through the guiding slot 32.

As the screw 35 inserted to the guiding slot 32 as the coupling member is coupled to the coupling boss 18 of the lower cover 14, the latch movable part 30 is coupled to the lower cover 14 to move in the transverse direction with respect to the moving direction of the latches 40.

The second spring member 34 includes a first part coupled to the spring coupling part 33, and a second part coupled to the screw 35 to provide the latch movable part 30 with the elastic force. The second spring member 34 causes the latch movable part 30 to be biased to the insertion direction.

The stopper 31 upwardly protrudes from the plate surface of the latch movable part 30, and comprises an inclination surface to correspond to the inclination part 46 of the latch 40. When the latch movable part 30 moves, the inclination part 46 of the latch 40 slidably contacts the inclination surface of the stopper 31 and moves along the traverse direction so that the latch 40 moves along the longitudinal direction of the latch 40. The traverse direction may have an angle with the insertion and/or separation directions of the battery assembly 10. The angle may be 90 degrees.

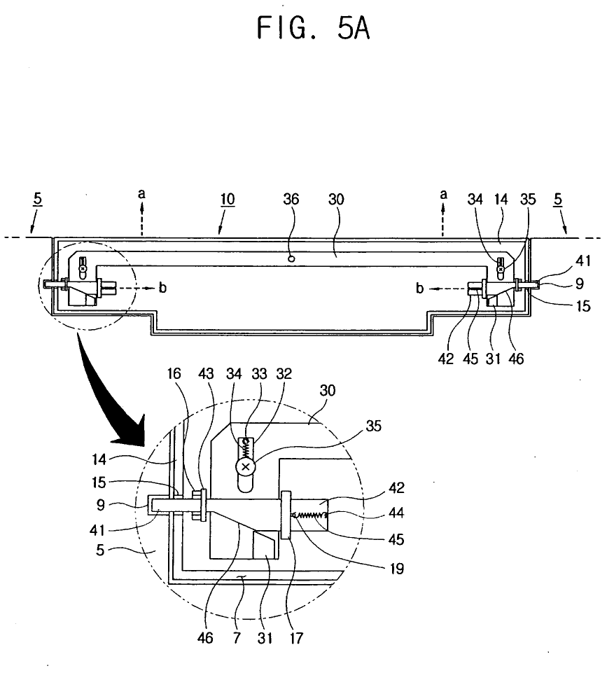

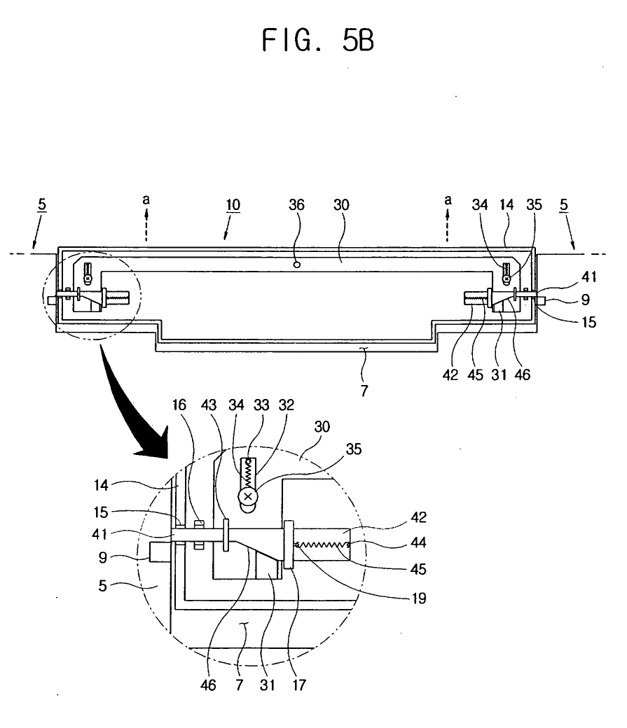

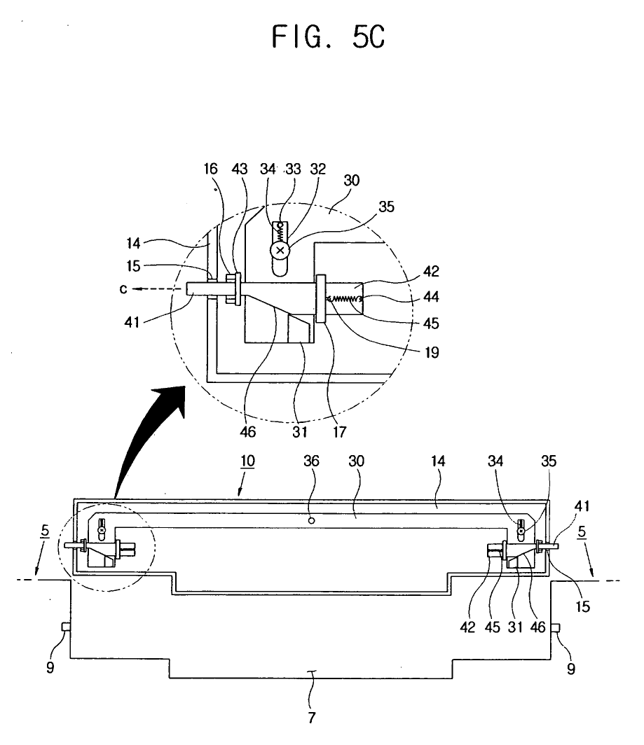

Hereinafter, a method of separating the battery assembly 10 from the computer main body 5 will be described with reference to FIGS. 5A through 5C.

Referring to FIG. 5A, when the battery assembly 10 is mounted in the battery mounting part 7 of the computer main body 5, the locking part 41 of the latch 40 is locked to the locking hole 9 of the computer main body 5 through the through hole 15 of the lower cover 14. Thus, the battery assembly 10 is not separated from the battery mounting part 7 of the computer main body 5.

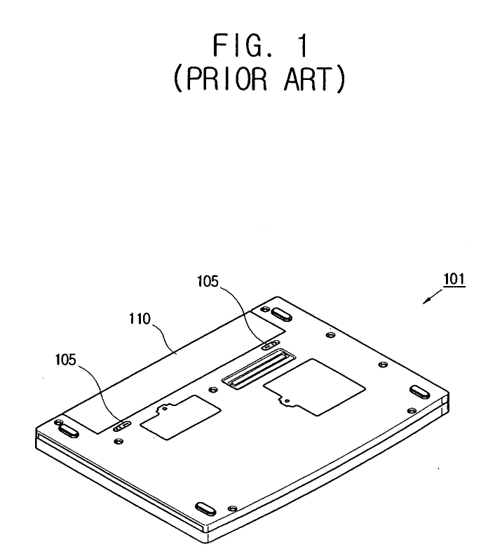

If a user moves the control knob 20 in the “a” direction (refer to FIG. 1) and pulls the battery assembly 10 in the “a” direction, the battery assembly 10 is separated from the battery mounting part 7 of the computer main body 5 without difficulty. The control knob 20 is movable together with the latch movable part 30 with respect to the upper 11 cover and/or the lower cover 14.

When the control knob 20 moves in the “a” direction, the latch movable part 30 integrally coupled to the control knob 20 moves in the “a” direction together with the control knob 20. At this time, the second spring member 34 is elastically extended. The second part of the second spring member 34 is fixed to the screw 35 coupled to the coupling boss 18 which is stationary, and the first part of the second spring member 34 is coupled to the spring coupling part 33 of the latch movable part 30 which is movable with respect to the screw 35 and the coupling boss 18 of the lower cover 14.

When the latch movable part 30 moves in the “a” direction, the latches 40 placed in front of the stopper 31 move in a “b” direction by the stopper 31, thereby releasing the locking part 41 from the locking hole 9. The inclination surface of the stopper 31 moves to push the inclination part 46 of the latch 40 in the “b” direction. That is, as the inclination part 46 of the latch 40 is engaged with the stopper 31 to slide in the “b” direction, the locking part 41 is released from the locking hole 9, and the first spring member 46 is elastically extended.

Referring to FIG. 5B, if the battery assembly 10 is continuously pulled to the “a” direction when the locking part 41 of the latch 40 is completely separated from the locking hole 9 of the computer main body 5, the battery assembly 10 is completely separated from the battery mounting part 7 of the computer main body 5. At this time, the locking part 41 of the latch 40 moves in a “c” direction of FIG. 5C by the elastic force of the first spring member 45, and the latch movable part 30 returns to an original position by the elastic force of the second spring member 34.

Meanwhile, if the battery assembly 10 is pushed along the battery mounting part 7, the locking part 41 of the latch 40 is locked to the locking hole 9 of the computer main body 5, thereby mounting the battery assembly 10 back to the battery mounting part 7.

As described above, in the portable computer 1 according to the present general inventive concept, when a user moves the control knob 20 in the “a” direction and pulls the battery assembly 10 to the “a” direction, the battery assembly 10 is separated from the battery mounting part 7 of the computer main body 5 without difficulty. As the moving direction of the control knob 20 releasing the battery assembly 10 from the computer main body 5 is the same as the direction of separating the battery assembly 10 from the compute main body 5, the battery assembly 10 is separated without difficulty, thereby improving user's convenience.

Although a few embodiments of the present general inventive concept have been shown and described, it will be appreciated by those skilled in the art that changes may be made in these embodiments without departing from the principles and spirit of the invention, the scope of which is defined in the appended claims and their equivalents.

What is claimed is:

1. A portable computer having a computer main body to which an attached object is detachably mounted, comprising:
a mounting part which is provided in the computer main body to accommodate an attached object;
engaging parts which are formed at opposite sides of the mounting part in a transverse direction with respect to a separation direction of the attached object;
insertion parts which are formed at opposite sides of the attached object corresponding to the engaging parts;
a latch which comprises a locking part locked to each engaging part through each insertion part and an inclination part inclined from the locking part, and is installed to the attached object to slide along a transverse direction with respect to the separation direction of the attached object; and
a latch movable part which comprises a stopper provided in a position corresponding to the inclination part, and is movable within the attached object in the separation direction of the attached object, the latch sliding between a locking position where the locking part is locked to the engaging part through the insertion part, and a releasing position where the locking part is released from the engaging part as the inclination part is engaged with the stopper and the inclination part slides according to a movement of the stopper when the latch movable part moves in the separation direction of the attached object.

2. The portable computer according to claim 1, wherein the attached object comprises a battery assembly having a battery, and
the battery assembly comprises a lower cover having an upward opening and an upper cover coupled to an upper part of the lower cover to close the upper opening.

3. The portable computer according to claim 2, wherein the latch comprises the locking part and the inclination part provided in a first portion thereof, a coupling part which is provided in a second portion thereof to be supported within the lower cover, and a flange which protrudes along a circumferential direction between the locking part and the inclination part.

4. The portable computer according to claim 3, further comprising:
a latch spring member to elastically move the latch from the releasing position to the locking position, having a first side supported within the lower cover and a second side supported by the coupling part.

5. The portable computer according to claim 4, wherein the lower cover comprises a front support which supports the locking part in front of the flange and a rear support which is disposed adjacent to the front support to support the coupling part therein.

6. The portable computer according to claim 1, further comprising a control knob which is coupled to the latch movable part to move together with the latch movable part in the separation direction of the attached object.

7. The portable computer according to claim 6, wherein the upper cover comprises an upper surface provided with a knob mounting part to movably accommodate the control knob, and a knob slot formed in a plate surface of the knob mounting part, and the control knob comprises a coupling projection which is provided in a lower part of the control knob to be coupled to the latch movable part within the attached object through the knob slot.

8. The portable computer according to claim 6, further comprising:
a guiding unit which guides the latch movable part to allow the latch movable part to move along the separation direction of the attached object in a lower part of the latch.

9. The portable computer according to claim 8, wherein the guiding unit comprises a coupling boss which protrudes from the lower cover, a guiding slot which is formed in the latch movable part to correspond to the coupling boss, and a coupling member which is inserted to the guiding slot to be coupled to the coupling boss.

10. The portable computer according to claim 8, further comprising:
a latch movable part spring member which elastically bias the latch movable part to an original position.

11. A portable computer having a computer main body and a battery assembly detachably attached to the computer main body, comprising:
a mounting part formed in the computer main body so that the battery assembly is mounted in and separated from the computer main body in a first direction;
a latch to move between locking and unlocking positions in a second direction to lock and unlock the battery assembly to and from the mounting part, respectively; and
a latch movably part to move in the first direction to control the latch to move in the second direction between the locking and unlocking positions.

12. The portable computer according to claim 11, wherein the battery assembly comprises a knob mounting part formed thereon, a knob slot formed in the knob mounting part, and a coupling projection coupled between the latch movable part and the knob mounting part through the knob slot.

13. The portable computer according to claim 12, wherein the knob slot has a length in the first direction to correspond to a moving distance of the latch movable part in the first direction.

14. The portable computer according to claim 11, wherein the mounting part comprises two sides, and the latch comprises first and second latches to move in the second direction to the lock and unlock positions with respect to the two sides of the mounting part.

15. The portable computer according to claim 11, wherein:
the battery assembly comprises a battery disposed between opposite sides of the battery assembly;
the mounting part comprises second opposite sides disposed to face the opposite sides of the battery assembly; and
the latch moves in the second direction between the lock and unlock positions to lock and unlock the opposite sides of the battery assembly with respect to the second opposite sides of the mounting part.

16. The portable computer according to claim 11, wherein the latch is disposed in the battery assembly to move in the second direction according to a movement of the latch movable part in the first direction.

17. The portable computer according to claim 11, wherein:
the latch is disposed in opposite sides of the battery assembly to be locked in the mounting part; and
the latch movable part disposed in the second direction to contact a surface of the latch.

18. The portable computer according to claim 11, wherein the latch comprises a surface having an angle with at least one of the first and second directions to convert a first force of the latch movable part in the first direction into a second force to move the latch in the second direction.

19. The portable computer according to claim 11, wherein the latch movable part comprises a middle portion disposed in the second direction and side plate surfaces formed ends thereof to control the latch to move in the second direction while moving in the first direction.

20. The portable computer according to claim 19, wherein:
the side plate surfaces are extended from the middle portion in the first direction;
the latch comprises first and second latches each having a surface having an angle with the second direction to contact corresponding ones of the end plate surfaces.

21. The portable computer according to claim 20, wherein the side plate surfaces each comprise a stopper to slidably contact the surface of the corresponding one of the first and second latches such that the stopper pushes the first and second latches in the second direction while moving in the first direction.

22. The portable computer according to claim 11, wherein:
the latch has a length in the second direction to move in the second direction;
the latch movable part has a second length in the second direction to move in the first direction to generate a force applied to the latch to move in the second direction.

23. The portable computer according to claim 11, wherein the first direction comprises an insertion direction in which the battery assembly is inserted into the mounting part and a separation direction in which the battery assembly is separated from the mounting part.

24. The portable computer according to claim 11, wherein the first direction is perpendicular to the second direction.

25. The portable computer according to claim 11, further comprising:
a first bias member coupled between the latch movable part and the latch; and
a second bias member coupled between the latch movable part and the mounting part.

26. A portable computer having a computer main body and a battery assembly detachably attached to the computer main body, comprising:
a mounting part formed in the computer main body so that the battery assembly is mounted in and separated from the computer main body in a first direction;
a latch movable part to move in the first direction; and
a latch having a first portion to convert a first force generated from the latch movable part in the first direction into a second force in a second direction, and a second portion to move between locking and unlocking positions in the second direction according to the second force of the first portion to lock and unlock the battery assembly to and from the mounting part, respectively.
